(19) United States
(12) Patent Application Publication
(10) Pub. No.: US 2015/0273883 A1
(43) Pub. Date: Oct. 1, 2015

(54) RECORDING METHOD

(71) Applicant: Seiko Epson Corporation, Tokyo (JP)

(72) Inventors: Ippei OKUDA, Shiojiri (JP); Akiko MATSUZAKI, Matsumoto (JP)

(21) Appl. No.: 14/671,094

(22) Filed: Mar. 27, 2015

(30) Foreign Application Priority Data
Mar. 28, 2014 (JP) 2014-070034
May 28, 2014 (JP) 2014-109752

(51) Int. Cl. B41J 11/00; B41J 2/21

(52) U.S. Cl. CPC B41J 11/0015; B41J 2/2114

(57) ABSTRACT

A recording method includes attaching a resin solution to a recording region of a recording medium, thereafter attaching a reaction solution including a flocculating agent to the recording region, and thereafter attaching an ink composition including at least one of a pigment and resin fine particles to the recording region. When an attachment amount of a region (A) where the attachment amount of a solid content included in the ink composition per unit area is the largest is 100%, in a case of having the region (A) and a range region which is from the region (A) up to a region (B) where the attachment amount of the solid content is 20%, at the range region, a ratio of the attachment amount of the solid content of the ink composition per unit area, and the attachment amount of the flocculating agent per unit area, is from 140:1 to 650:1.

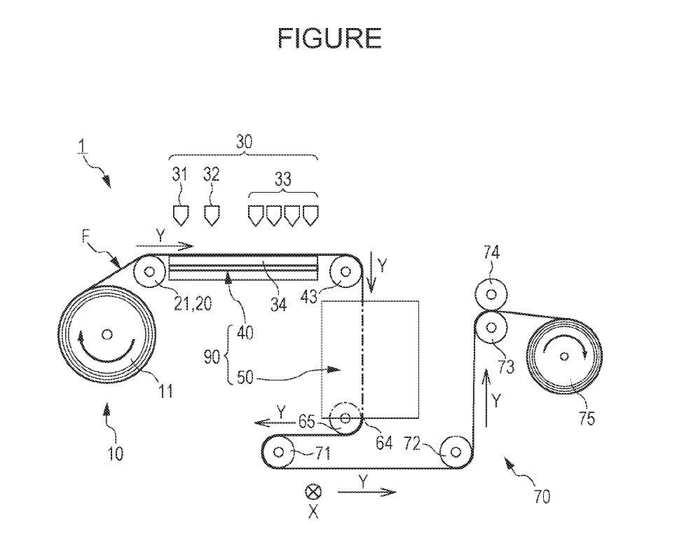

### BACKGROUND

1. Technical Field

The present invention relates to a recording method.

2. Related Art

An ink jet recording method is capable of recording a high definition image by a relatively simple apparatus, and has achieved rapid development in various fields. Among them, various studies have been made regarding discharge stability or the like. For example, in JP-A-2005-262576, in an ink jet recording system where an image is formed by printing of a type such that a head is reciprocatingly scanned, it is disclosed an ink jet recording method of which an object is to provide an ink jet recording method with no occurrence of an image difference or a drying time difference at the time of bidirectional printing, and which satisfies a relationship which is indicated in Expression (1), when addition amounts of an ink and a liquid composition per unit area in a case of adding the liquid composition after the ink is added to a recording medium ahead, are respectively a1 and b1, and the addition amounts of the ink and the liquid composition per unit area in the case of adding the ink after the liquid composition is added to the recording medium ahead, are respectively a2 and b2, at the time of forming the image.

b2/a2<b1/a1 Expression (1)

(In Expression (1), respectively, a1 and b1 have the relationship of a1>b1, and a2 and b2 have the relationship of a2>b2.)

However, in the recording method of the related art, since the liquid composition containing a component which flocculates and/or thickens the ink, has mainly deliquescent properties, if a use amount becomes large, a recording material becomes sticky, and wet abrasion resistance of the recording material is lowered. On the other hand, if the use amount becomes small, stickiness unevenness or bleeding occurs in the recording material.

### SUMMARY

An advantage of some aspects of the invention is to provide a recording method that can obtain a recording material which is excellent in wet abrasion resistance, and in which stickiness unevenness or bleeding is unlikely to occur.

The inventors have extensively made studies to solve the above problems. As a result, it is found out that the problem is solved by a recording method having a predetermined process, and the invention is completed.

In other words, the invention is as follows.

[1] According to an aspect of the invention, there is provided a recording method including attaching a resin solution including a resin, to a recording region of a recording medium, attaching a reaction solution including a flocculating agent which flocculates components of an ink composition, to the recording region to which the resin solution is attached, and attaching an ink composition including at least any one of a pigment and resin fine particles, to the recording region to which the reaction solution is attached, in which in the recording region, when an attachment amount of a region (A) where the attachment amount of a solid content which is included in the ink composition per unit area is the largest is 100%, in a case of having the region (A) and a region of a range which is from the region (A) up to a region (B) where the attachment amount of the solid content is 20%, at the region of the range, a ratio of the attachment amount (unit: g) of the solid content of the ink composition per unit area, and the attachment amount (unit: mol) of the flocculating agent per unit area, is from 140:1 to 650:1.

[2] In the recording method according to the above [1], in the attaching of the reaction solution, the reaction solution may be attached by an ink jet system, to the recording region to which the resin solution is attached.

[3] In the recording method according to the above [1] or [2], in the case of having the region (A) and the region of the range, at the region of the range, the ratio of the attachment amount (unit: g) of the solid content which is included in the ink composition per unit area, and the attachment amount (unit: mol) of the flocculating agent per unit area, may be from 300:1 to 650:1.

[4] In the recording method according to any one of the above [1] to [3], when 3 mL of a resin aqueous medium solution including the resin fine particles of 1 mass %, and 3 mL or less of a calcium nitrate aqueous solution of 0.085 mol/L are mixed, the ink composition may include the resin fine particles having flocculating properties, as a resin fine particle.

[5] In the recording method according to any one of the above [1] to [4], the recording medium may be a low absorption recording medium, or a non-absorption recording medium.

[6] In the recording method according to the above [5], in the attaching of the ink composition, the ink compositions of two types or more, may be attached to the recording region, and the attachment amount of the solid content which is included in the ink composition per unit area, may be a total attachment amount of the solid contents which are included in the ink compositions of two types or more.

[7] In the recording method according to any one of the above [1] to [6], the ink composition may include a clear ink.

[8] In the recording method according to any one of the above [1] to [7], in the case of having the region (A) and the region of the range, at the region of the range, the attachment amount of the solid content which is included in the ink composition per unit area, may be from 0.04 mg/inch² to 0.40 mg/inch².

[9] In the recording method according to any one of the above [1] to [8], in the case of having the region (A) and the region of the range, at the region of the range, the attachment amount of the flocculating agent per unit area, may be from 0.08×10⁻³ mmol/inch² to 1.8×10⁻³ mmol/inch².

[10] In the recording method according to any one of the above [1] to [9], in the case of having the region (A) and the region of the range, at the region of the range, the attachment amount of the resin which is included in the resin solution per unit area, may be from 0.05 mg/inch² to 0.50 mg/inch².

[11] In the recording method according to any one of the above [1] to [10], the resin which is included in the resin solution, may include the resin fine particles.

[12] In the recording method according to any one of the above [1] to [11], the flocculating agent may include at least any one of a polyvalent metal salt and an organic acid.

### BRIEF DESCRIPTION OF THE DRAWING

The invention will be described with reference to the accompanying drawings, wherein like numbers reference like elements.

FIGURE is a side view illustrating an outline of an example of an ink jet recording apparatus which can be used in an embodiment of the invention.

### DESCRIPTION OF EXEMPLARY EMBODIMENTS

Hereinafter, a form for embodying the invention (referred to as embodiment, hereinafter) will be described with reference to a drawing as necessary, but the invention is not limited thereto, and can be variously modified within the scope without departing the gist thereof. In the drawing, the same signs are attached to the same components, and the overlapping description will be omitted. Moreover, a positional relationship such as up and down or right and left, is based on the positional relationship illustrated in the drawing, as long as being not informed in particular. Furthermore, a dimensional ratio of the drawing is not limited to the ratio illustrated in the drawing.

### Recording Method

A recording method of the present embodiment includes attaching a resin solution including a resin, to a recording region of a recording medium, attaching a reaction solution including a flocculating agent, to the recording region to which the resin solution is attached, and attaching an ink composition including at least any one of a pigment and resin fine particles, to the recording region to which the reaction solution is attached, in which in the recording region, when an attachment amount of a region (A) where the attachment amount of a solid content which is included in the ink composition per unit area is the largest is 100%, in a case of having the region (A) and a region of a range which is from the region (A) up to a region (B) where the attachment amount of the solid content is 20%, at the region of the range, a ratio of the attachment amount (unit: g) of the solid content of the ink composition per unit area, and the attachment amount (unit: mol) of the flocculating agent per unit area, is from 140:1 to 650:1.

### Attaching of Resin Solution

The attaching of the resin solution is to attach the resin solution including the resin, to the recording region of the recording medium. A unit that attaches the resin solution is not particularly limited, but for example, a roller coating, a spray coating, or an ink jet system may be used. In this manner, by using the resin solution, it is possible to prevent infiltration of the flocculating agent into the recording medium. Hereby, since reaction efficiency of the reaction solution and the ink composition is enhanced, it is possible to further reduce a use amount of the reaction solution.

### Recording Medium

As a recording medium, for example, an absorption recording medium, a low absorption recording medium, or a non-absorption recording medium may be used. Among them, it is preferable that the recording medium is the low absorption recording medium, or the non-absorption recording medium. When the low absorption recording medium or the non-absorption recording medium is used, since the reaction solution is hit onto a surface thereof, and the flocculating agent is unlikely to be uniformly coated, stickiness unevenness or bleeding is more likely to occur. However, in the embodiment, since it is possible to prevent the reaction solution from being hit by the resin solution, it is particularly useful. Moreover, when the low absorption recording medium or the non-absorption recording medium is used, since the flocculating agent is likely to remain on a surface of the recording medium without infiltrating into the recording medium, stickiness or wet abrasion resistance of a recording face may be degraded. However, in the embodiment, since it is possible to reduce the use amount of the reaction solution by using the resin solution, it is possible to improve the stickiness of the recording face, and it is particularly useful. Furthermore, “recording region” is referred to as a region where an image is formed on the surface of the recording medium.

Here, “low absorption recording medium” or “non-absorption recording medium” is referred to as a recording medium of which a water absorption amount to 30 msec from a contact start in a Bristow method, is 10 mL/m² or less. The Bristow method is a method which is most widely used as a measurement method of a liquid absorption amount for a short time, and is adopted by Japan Technical Association of the Pulp and Paper Industry (JAPAN TAPPI). The details of a test method are written in a standard No. 51 “paper and paperboard—liquid absorbency test method—Bristow method” of “JAPAN TAPPI paper pulp test method in 2000”.

Moreover, the non-absorption recording medium or the low absorption recording medium can be classified depending on wettability with respect to the water of the recording face. Specifically, water droplets of 0.5 μL are dropped to the recording face of the recording medium, and a lowering rate (comparison the contact angle in 0.5 msec after landing with the contact angle in 5 seconds) of a contact angle is measured, and thereby, it is possible to characterize the recording medium. More specifically, as properties of the recording medium, the non-absorption property of “non-absorption recording medium” is indicated that the lowering rate is less than 1%, and the low absorption property of “low absorption recording medium” is indicated that the lowering rate is 1% or more and less than 5%. Still more, the absorption property is indicated that the lowering rate is 5% or more. Furthermore, the contact angle can be measured using a portable contact angle meter PCA-1 (manufactured by Kyowa Interface Science Co., Ltd.) or the like.

The absorption recording medium is not particularly limited, but for example, plain paper such as electron photo paper where the infiltration properties of the ink composition are high, ink jet paper (ink jet dedicated paper including an ink absorption layer which is configured from silica particles or alumina particles, or the ink absorption layer which is configured from a hydrophilic polymer such as polyvinyl alcohol (PVA) or polyvinyl pyrrolidone (PVP)), art paper where the infiltration properties of the ink composition are relatively low, and which is used in the general offset printing, coated paper, cast paper, or the like may be used.

The low absorption recording medium is not particularly limited, but for example, coating paper where a coating layer for accepting an oil-based ink on the surface is arranged, may be used. The coating paper is not particularly limited, but for example, actual printing paper such as the art paper, the coated paper or matte paper, may be used.

The non-absorption recording medium is not particularly limited, but for example, a plastic film having no ink absorption layer, the recording medium where the plastic is coated on a base material such as the paper, the recording medium to which the plastic film is stuck, or the like may be used. Here, as plastic, polyvinyl chloride, polyethylene terephthalate, polycarbonate, polystyrene, polyurethane, polyethylene, polypropylene or the like may be used.

Furthermore, in addition to the above recording media, a plate of metals such as iron, silver, copper or aluminum, an ink non-absorption recording medium such as glass, or an ink low absorption recording medium, may be used.

### Resin Solution

The resin solution includes the resin. The resin is not particularly limited, but for example, polyester-based resin fine particles, polyethylene-based resin fine particles, or urethane-based resin fine particles may be used. Among them, it is preferable that the resin includes the resin fine particles. As resin fine particles, for example, polyester-based resin fine particles (for example, a trade name “VYLONAL MD-1500” manufactured by Toyobo Co., Ltd.), polyethylene-based resin fine particles (for example, the trade name “ZAIKTHENE A” manufactured by Sumitomo Seika Chemicals Co., Ltd.), or urethane-based resin fine particles (for example, the trade name “RESAMINE D4200” manufactured by Dainichiseika Color & Chemicals Mfg. Co., Ltd.) may be used. By including such the resin fine particles, the use amount of a processing solution can be reduced, and the stickiness, the stickiness unevenness and the bleeding of the recording face, may be further suppressed. The resin and the resin fine particles are used in one type alone, or are used by combining two types or more.

A content of the resin is preferably from 1.0 part by mass to 12.5 parts by mass, with respect to a total amount of the resin solution (100 parts by mass), and is more preferably from 1.0 part by mass to 10 parts by mass, and is further more preferably from 2.5 parts by mass to 7.5 parts by mass. The content of the resin is 1.0 part by mass or more, and thereby, the use amount of the processing solution can be reduced, and the stickiness, the stickiness unevenness and the bleeding of the recording face, may be further suppressed. Moreover, the content of the resin is 12.5 parts by mass or less, and thereby, the wet abrasion resistance may be further enhanced. When the resin solution is coated by the ink jet system, it is preferable that the above range is particularly used from a point of being excellent in discharge stability. When the resin solution is coated by the system such as a coater other than the ink jet system, the content of the resin may be in the range other than the above range, and is not particularly limited.

Various addition agents such as the same surfactant as the surfactant which is used in the following processing solution, the same solvent as the solvent which is used in the following processing solution, a dissolution aid, a viscosity adjusting agent, a pH adjusting agent, an oxidation inhibitor, a preservative, a mildew proofing agent, a corrosion inhibitor, and a chelating agent for capturing metal ions which have an effect on dispersion, may be appropriately added to the resin solution which is used in the embodiment.

### Attaching of Reaction Solution

The attaching of the reaction solution is to attach the reaction solution including the flocculating agent, to the recording region to which the resin solution is attached. The unit that attaches the reaction solution is not particularly limited, but for example, the roller coating, the spray coating, or the ink jet system may be used. Among them, it is preferable that the reaction solution is attached by the ink jet system, to the recording region to which the resin solution is attached. By attaching the reaction solution by the ink jet system, a face quality change of the media is suppressed, and the wet abrasion resistance may be enhanced.

### Reaction Solution

The reaction solution includes the flocculating agent. The flocculating agent in the reaction solution, interacts with the ink composition, and thereby, the ink composition is thickened or insolubilized by flocculating the components which are included in the ink composition. Hereby, it is possible to prevent landing interference or bleeding of the ink composition which is attached thereafter, and it is possible to uniformly draw a line or a fine image. The flocculating agent is not particularly limited, but for example, a polyvalent metal salt and an organic acid may be used. It is preferable that the flocculating agent includes at least any one of the polyvalent metal salt and the organic acid. The flocculating agent includes at least any one of the polyvalent metal salt and the organic acid, and thereby, the stickiness unevenness and the bleeding may be further suppressed. As a component which is flocculated by the flocculating agent, and is included in the ink composition, the pigment and the resin fine particles described later, may be used.

### Polyvalent Metal Salt

The polyvalent metal salt is not particularly limited, but for example, it is preferable that the polyvalent metal salt is a polyvalent metal salt of an inorganic acid, or a polyvalent metal salt of an organic acid. Such the polyvalent metal salt is not particularly limited, but for example, Group 2 alkaline earth metal (such as magnesium or calcium) of the periodic table, Group 3 transition metal (such as lanthanum) of the periodic table, earth metal (such as aluminum) from Group 13 of the periodic table, or a salt of lanthanides (such as neodymium) may be used. As a salt of the polyvalent metal, a carboxylate (such as formic acid, acetic acid or benzoic acid), a sulfate, a nitrate, a chloride, and a thiocyanate are suitable. Among them, it is preferable that a calcium salt or a magnesium salt of carboxylic acid (such as the formic acid, the acetic acid, or the benzoic acid), the calcium salt or the magnesium salt of sulfuric acid, the calcium salt or the magnesium salt of nitric acid, calcium chloride, magnesium chloride, or the calcium salt or the magnesium salt of thiocyanic acid, is used. Furthermore, the polyvalent metal salt may be used in one type alone, or may be used together in two types or more.

### Organic Acid

The organic acid is not particularly limited, but for example, acetic acid, phosphoric acid, oxalic acid, malonic acid, citric acid may be used. Among them, it is preferable that the organic acid is the carboxylic acid of monovalent or divalent or more. By including the carboxylic acid, the flocculating effect of a resin fine particle (A) is enhanced, and may be more excellent in coloring properties. Furthermore, the organic acid may be used in one type alone, or may be used together in two types or more.

The content of the flocculating agent is preferably from 1.0 part by mass to 30 parts by mass, with respect to the total amount of the reaction solution (100 parts by mass), and is more preferably from 3.0 parts by mass to 27.5 parts by mass, and is further more preferably from 3.0 parts by mass to 22.5 parts by mass. The content of the flocculating agent is in the above range, and thereby, the stickiness unevenness and the bleeding may be further suppressed.

The reaction solution can include other components, as necessary. Other components are not particularly limited, but for example, the surfactant, the solvent or the like, may be used.

### Surfactant

It is preferable that the reaction solution includes the surfactant. The surfactant is not particularly limited, but for example, an acetylene glycol-based surfactant, a fluorine-based surfactant, or a silicone-based surfactant may be used.

The acetylene glycol-based surfactant is not particularly limited, but for example, it is preferable that the acetylene glycol-based surfactant is one type or more which is selected from 2,4,7,9-tetramethyl-5-decyne-4,7-diol, an alkylene oxide adduct of 2,4,7,9-tetramethyl-5-decyne-4,7-diol, 2,4-dimethyl-5-decyne-4-ol, and an alkylene oxide adduct of 2,4-dimethyl-5-decyne-4-ol. A commercially available product of the acetylene glycol-based surfactant is not particularly limited, but for example, Olfin 104 series or E-series such as Olfin E1010 (products names manufactured by Air Products and Chemicals, Inc. (Air Products Japan, Inc.)), Surfynol 465 or Surfynol 61 (trade names manufactured by Nissin Chemical Industry CO., Ltd.) or the like, may be used. The acetylene glycol-based surfactant may be used in one type alone, or may be used together in two types or more.

The fluorine-based surfactant is not particularly limited, but for example, a perfluoroalkyl sulfonate, a perfluoroalkyl carboxylate, a perfluoroalkyl phosphate ester, a perfluoroalkyl ethylene oxide adduct, a perfluoroalkyl betaine, or a perfluoroalkyl amine oxide compound may be used. The commercially available product of the fluorine-based surfactant is not particularly limited, but for example, S-144 or S-145 (manufactured by Asahi Glass Co., Ltd.), FC-170C, FC-430 or Fluorad-FC4430 (manufactured by Sumitomo 3M Limited), FSO, FSO-100, FSN, FSN-100 or FS-300 (manufactured by DuPont Co., Ltd.), FT-250 or FT-251 (manufactured by Neos Co., Ltd.) or the like, may be used. The fluorine-based surfactant may be used in one type alone, or may be used together in two types or more.

As a silicone-based surfactant, polysiloxane-based compound, polyether-modified organosiloxane or the like, may be used. The commercially available product of the silicone-based surfactant is not particularly limited, but specifically, BYK-306, BYK-307, BYK-333, BYK-341, BYK-345, BYK-346, BYK-347, BYK-348 or BYK-349 (trade names manufactured by BYK Japan Co., Ltd.), KF-351A, KF-352A, KF-353, KF-354L, KF-355A, KF-615A, KF-945, KF-640, KF-642, KF-643, KF-6020, X-22-4515, KF-6011, KF-6012, KF-6015 or KF-6017 (trade names manufactured by Shin-Etsu Chemical Co., Ltd.) or the like, may be used. The silicone-based surfactant may be used in one type alone, or may be used together in two types or more.

The content of the surfactant is preferably from 0.050 parts by mass to 2.5 parts by mass, with respect to the total amount of the reaction solution (100 parts by mass), and is more preferably from 0.10 part by mass to 2.0 parts by mass. The content of the surfactant is in the above range, and thereby, the wettability of the reaction solution which is attached to the recording medium, may be further enhanced.

### Solvent

The solvent is not particularly limited, but for example, the solvent can use an organic solvent or the water.

As the water, for example, pure water such as ion exchanged water, ultrafiltered water, reverse osmosis water or distilled water, and ultrapure water, that is, the water in which ionic impurities are removed to the utmost, may be used. Additionally, if the water which is sterilized by ultraviolet irradiation or the addition of hydrogen peroxide, is used, it is possible to prevent the occurrence of mold or bacteria in the case of storing the reaction solution for a long time. Hereby, the storage stability may be further enhanced.

The organic solvent is not particularly limited, but for example, a hydrocarbon-based solvent such as toluene, hexane, cyclohexane, benzene, octane or isooctane, an ester-based solvent such as ethyl acetate, butyl acetate or 7-butyrolactone, a ketone-based solvent such as acetone, methyl ethyl ketone, methyl isobutyl ketone or cyclohexanone, an alcohol-based solvent such as methanol, ethanol, propanol, isopropanol or butanol, a halogen-based solvent such as dichloroethane or chloroform, an ether-based solvent such as diethyl ether or tetrahydrofuran, an amide-based solvent such as N,N-dimethylformamide, N,N-dimethylacetamide, N-methyl-2-pyrrolidone, N-ethyl-2-pyrrolidone, 2-pyrrolidone, N-methyl-ε-caprolactam or hexamethylphosphoramide, glycerin, triethylene glycol, triethylene glycol monobutyl ether, or water-soluble organic solvent may be used.

### Attaching of Ink Composition

The attaching of the ink composition is to attach the ink composition including at least any one of the pigment and the resin fine particles, to the recording region to which the reaction solution is attached. The unit that attaches the ink composition is not particularly limited, but for example, the ink jet system can be used.

### Ink Composition

The ink composition includes at least any one of the pigment and the resin fine particles. The ink composition may be a clear ink. Here, “clear ink” is not an ink composition which is used for colorizing the recording medium, and is a composition which is used for the improvement of the quality such as glossiness or abrasion resistance of a recording material. The content of a color material is preferably 0.2 mass % or less, and is more preferably to be an ink composition which does not include the color material. Moreover, in the attaching of the ink composition, it is possible to attach the ink compositions of two types or more to the recording region. When the ink compositions of two types of more are used, it is preferable that at least one thereof is the clear ink. By using the clear ink, the wet abrasion resistance may be further enhanced, and it is more preferable from the point that an attachment amount ratio is likely to enter the range described above.

### Pigment

The pigment is not particularly limited, but for example, the following pigments may be used.

Carbon black which is used in the clear ink, is not particularly limited, but for example, No. 2300, No. 900, MCF88, No. 33, No. 40, No. 45, No. 52, MA7, MA8, MA100, No. 2200B or the like (manufactured by Mitsubishi Chemical Corporation), Raven 5750, Raven 5250, Raven 5000, Raven 3500, Raven 1255, Raven 700 or the like (manufactured by Columbia carbon (Carbon Columbia) Co., Ltd.), Regal 400R, Regal 330R, Regal 660R, Mogul L, Monarch 700, Monarch 800, Monarch 880, Monarch 900, Monarch 1000, Monarch 1100, Monarch 1300, Monarch 1400 or the like (manufactured by Cabot Corporation (CABOT JAPAN K.K.)), Color Black FW1, Color Black FW2, Color Black FW2V, Color Black FW18, Color Black FW200, Color Black S150, Color Black 5160, Color Black S170, Printex 35, Printex U, Printex V, Printex 140U, Special Black 6, Special Black 5, Special Black 4A or Special Black 4 (manufactured by Degussa Co., Ltd.), may be used.

The pigment which is used in a white ink, is not particularly limited, but for example, C.I. Pigment White 6, 18 or 21, a titanium oxide, a zinc oxide, a zinc sulfide, an antimony oxide, a zirconium oxide, white hollow resin particles, or white polymer particles may be used.

The pigment which is used in a yellow ink, is not particularly limited, but for example, C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172 or 180, may be used.

The pigment which is used in a magenta ink, is not particularly limited, but for example, C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48:2, 48:5, 57:1, 88, 112, 114, 122, 123, 144, 146, 149, 150, 166, 168, 170, 171, 175, 176, 177, 178, 179, 184, 185, 187, 202, 209, 219, 224 or 245, or C.I. Pigment Violet 19, 23, 32, 33, 36, 38, 43 or 50, may be used.

The pigment which is used in a cyan ink, is not particularly limited, but for example, C.I. Pigment Blue 1, 2, 3, 15, 15:1, 15:2, 15:3, 15:34, 15:4, 16, 18, 22, 25, 60, 65 or 66, or C.I. Bat Blue 4 or 60, may be used.

In addition to the pigments described above, other pigments are not particularly limited, but for example, C.I. Pigment Green 7 or 10, C.I. Pigment Brown 3, 5, 25 or 26, C.I. Pigment Orange 1, 2, 5, 7, 13, 14, 15, 16, 24, 34, 36, 38, 40, 43 or 63, may be used.

The content of the pigment is preferably from 0.2 parts by mass to 10 parts by mass, with respect to the total amount of the ink composition (100 parts by mass), and is more preferably from 1.0 part by mass to 10.0 parts by mass, and is further more preferably from 2.0 parts by mass to 10.0 parts by mass. The content of the pigment is in the above range, and thereby, the coloring properties may be further enhanced.

### Resin Fine Particle

By using the resin fine particles, since the pigment is fixed to the recording medium by fusing each of the resins among the resin fine particles, and the resin and the pigment with each other, the abrasion resistance and adhesiveness of an image portion of the recording material can be made better. It is preferable that a urethane-based resin, an acryl-based resin or a polyethylene-based resin among the resin fine particles, is used.

As a urethane-based resin, for example, a urethane resin emulsion may be used. If the urethane resin emulsion is a resin emulsion having a urethane bond in molecules, the urethane resin emulsion is not particularly limited, and a polyether type urethane resin having an ether bond in a main chain, a polyester type urethane resin having an ester bond in the main chain, or a polycarbonate type urethane resin having a carbonate bond in the main chain, may be used. The commercially available product of the urethane resin emulsion is not particularly limited, but for example, Sun Cure 2710 (trade name manufactured by Lubrizol Japan Corporation (The Lubrizol Corporation)), Pamarin UA-150 (trade name manufactured by Sanyo Chemical Industries, Ltd.), Super Flex 460, 470, 610 or 700 (trade name manufactured by Dai-ichi Kogyo Seiyaku Co., Ltd.), Neo Rez R-9660, R-9637 or R-940 (trade name manufactured by Kusumoto Chemicals, Ltd.), Adeka BONTIGHTER HUX-380 or 290K (trade name manufactured by Adeka Corporation), Takelac (registered trademark) W-605, W-635 or WS-6021 (trade name manufactured by Mitsui Chemicals, Inc.), or polyether (trade name manufactured by Taisei Fine Chemical Co., Ltd., Tg=20° C.) may be used.

As an acryl-based resin, for example, an acryl resin emulsion may be used. The acryl resin emulsion is not particularly limited, but for example, the acryl resin emulsion which is obtained by polymerizing (meth)acryl-based monomer such as (meth)acrylic acid or (meth)acrylic acid ester, or the acryl resin emulsion which is obtained by copolymerizing the (meth)acryl-based monomer with other monomers, may be used. The commercially available product of acryl resin fine particles, is not particularly limited, but for example, Movinyl 966A (trade name manufactured by Nippon Synthetic Chemical Co., Ltd. (Nippon Synthetic Chemical Industry Co., Ltd.)), Microgel E-1002 or Microgel E-5002 (trade name manufactured by Nippon Paint Co., Ltd.), Boncoat 4001 or Boncoat 5454 (trade name manufactured by DIC Corporation), SAE1014 (trade name manufactured by Nippon Zeon Co., Ltd. (Zeon Corporation)), Saibinol SK-200 (trade name manufactured by Saiden Chemical Co., Ltd. (Saiden Chemical Industry Co., Ltd.)), Joncyrl 7100, Joncryl 390, Joncryl 711, Joncryl 511, Joncryl 7001, Joncryl 632, Joncryl 741, Joncryl 450, Joncryl 840, Joncryl 62J, Joncryl 74J, Joncryl HRC-1645J, Joncryl 734, Joncryl 852, Joncryl 7600, Joncryl 775, Joncryl 537J, Joncryl 1535, Joncryl PDX-7630A, Joncryl 352J, Joncryl 352D, Joncryl PDX-7145, Joncryl 538J, Joncryl 7640, Joncryl 7641, Joncryl 631, Joncryl 790, Joncryl 780 or Joncryl 7610 (trade name manufactured by BASF Corporation), or NK binder R-5HN (trade name manufactured by Shin-Nakamura Chemical Co., Ltd., solid content 44%), may be used.

Among them, it is preferable that at least one type selected from a group which is made up of the (meth)acryl-based resin and the styrene-(meth)acrylic acid copolymer-based resin, is used. It is more preferable that at least one type selected from the group which is made up of the acryl-based resin and the styrene-acrylic acid copolymer-based resin, is used, and it is further more preferable that the styrene-acrylic acid copolymer-based resin is used. The above copolymer may have any form of random copolymer, block copolymer, alternating copolymer, and graft copolymer.

The resin fine particles may be used in one type alone, or may be used by combining two types or more.

The content of the resin of the resin fine particles, is preferably from 1.0 part by mass to 11 parts by mass, with respect to the total amount of the ink composition, and is more preferably from 1.0 part by mass to 9.0 parts by mass, and is further more preferably from 1.0 part by mass to 7.0 parts by mass. The content of the resin of the resin fine particles, is in the above range, and thereby, the stickiness unevenness and the bleeding may be further suppressed, and the wet abrasion resistance may be further enhanced.

### Flocculating Resin

It is preferable that a flocculating resin among the resin fine particles described above is particularly included. The ink composition includes the flocculating resin, and thereby, the stickiness unevenness and the bleeding may be further suppressed. It is preferable that the resin fine particles have flocculating properties when a resin aqueous solution including the resin fine particles of 1 mass % (simply referred to as “resin aqueous solution”, hereinafter. The resin aqueous solution means a resin solution (resin aqueous medium solution) which uses the water as a medium, and it is meant that water dispersion is also included in the aqueous solution.), and a calcium nitrate aqueous solution of 0.085 mol/L (simply referred to as “calcium nitrate aqueous solution”, hereinafter) are mixed. It is more preferable that the resin fine particles have the flocculating properties when 3 mL of the resin aqueous solution, and 3 mL or less of the calcium nitrate aqueous solution are mixed. The resin in such the case is defined as a flocculating resin, and it is further more preferable that the resin fine particles have the flocculating properties when 3 mL of the resin aqueous solution, and 1.0 mL or less of the calcium nitrate aqueous solution are mixed. A volume of the mixed calcium nitrate aqueous solution is not limited, but can be 0.1 mL or more.

Such the flocculating resin is not particularly limited, but for example, a polyethylene-based resin (for example, “Chemipearl S650” that is the trade name manufactured by Mitsui Chemicals, Inc.), a polyethylene-based resin (for example, “AQ515” that is the trade name manufactured by BYK Co., Ltd.), or a polyester-based resin (for example, “KT8701” that is the trade name manufactured by Unitika Co., Ltd.) may be used.

Various addition agents such as the same surfactant as the surfactant which is used in the above processing solution, the same solvent as the solvent which is used in the above processing solution, the dissolution aid, the viscosity adjusting agent, the pH adjusting agent, the oxidation inhibitor, the preservative, the mildew proofing agent, the corrosion inhibitor, and the chelating agent for capturing the metal ions which have the effect on the dispersion, may be appropriately added to the ink composition which is used in the embodiment. Moreover, a water-soluble resin may be further contained. The water-soluble resin has the similar function to the resin fine particles described above, and the abrasion resistance and the adhesiveness of the image portion of the recording material can be made better.

### Attachment Amount

In the recording region, when the attachment amount of the region (A) where the attachment amount of the solid content which is included in the ink composition per unit area is the largest is 100%, in the case of having the region (A) and the region of the range which is from the region (A) up to the region (B) where the attachment amount of the solid content is 20%, at the region of the range, a ratio (I) of the attachment amount (unit: g) of the solid content of the ink composition per unit area, and the attachment amount (unit: mol) of the flocculating agent per unit area, is from 140:1 to 650:1, and it is preferably to be from 300:1 to 650:1. The ratio (I) is 140:1 or more, and thereby, the stickiness is reduced, and the wet abrasion resistance of the obtained recording material may be further enhanced. Moreover, the ratio (I) is 650:1 or less, and thereby, the stickiness unevenness and the bleeding may be further suppressed.

It is preferable that the ratio (I) is satisfied in the region where the attachment amount of the solid content which is included in the ink composition per unit area is 100% to 20%. Hereby, throughout the whole of the recording region, the stickiness is reduced, and the wet abrasion resistance of the obtained recording material is further enhanced. Furthermore, the stickiness unevenness and the bleeding may be further suppressed. When the recording method of the embodiment relating to the region of the above range has such the region, the ratio of the attachment amounts may be in the above range, and the recording method may be a recording method which does not have the above range. For example, the recording method may be a recording method having only the region (A). Moreover, in the case of having the region of the above range, the recording method may have at least a partial region among the above range. When the recording method has the region of the above range, it is preferable from the point that a color reproduction region of the image is widened.

The “solid content which is included in the ink composition” is referred to as a non-volatile component which is included in the ink composition. Specifically, at least the pigment and the resin fine particles are included therein.

In the attaching of the resin solution, when the resin solutions of two types or more are attached to the recording region, the attachment amount of the resin solution per unit area, is a total attachment amount of the resin solutions of two types or more. Moreover, in the attaching of the reaction solution, when the reaction solutions of two types or more are attached to the recording region, the attachment amount of the flocculating agent per unit area, is the total attachment amount of the flocculating agents which are included in the reaction solutions of two types or more. Still more, in the attaching of the ink composition, when the ink compositions of two types or more are attached to the recording region, the attachment amount of the solid content which is included in the ink composition per unit area, is the total attachment amount of the solid contents which are included in the ink compositions of two types or more.

In (the case of having) the region (A) and the region of the range which is from the region (A) up to the region (B), the attachment amount of the solid content which is included in the ink composition per unit area, is preferably from 0.04 mg/inch² to 0.40 mg/inch², and is more preferably from 0.04 mg/inch² to 0.30 mg/inch², and is further more preferably from 0.04 mg/inch² to 0.28 mg/inch². The attachment amount of the solid content which is included in the ink composition per unit area, is 0.04 mg/inch² or more, and thereby, the wet abrasion resistance and the stickiness of the recording face may be further enhanced. Moreover, the attachment amount of the solid content which is included in the ink composition per unit area, is 0.40 mg/inch² or less, and thereby, the stickiness unevenness and the bleeding may be further suppressed.

In the region (A), the attachment amount of the solid content which is included in the ink composition per unit area, is preferably from 0.10 mg/inch² to 0.60 mg/inch², and is more preferably from 0.15 mg/inch² to 0.50 mg/inch², and is further more preferably from 0.20 mg/inch² to 0.40 mg/inch². In the region (A), the attachment amount of the solid content which is included in the ink composition per unit area, is 0.10 mg/inch² or more, and thereby, the wet abrasion resistance and the stickiness of the recording face may be further enhanced. Moreover, in the region (A), the attachment amount of the solid content which is included in the ink composition per unit area, is 0.60 mg/inch² or less, and thereby, the stickiness unevenness and the bleeding may be further suppressed.

In (the case of having) the region (A) and the region of the range which is from the region (A) up to the region (B), the attachment amount of the flocculating agent per unit area, is preferably from 0.08×10⁻³ mmol/inch² to 1.8×10⁻³ mmol/inch², and is more preferably from 0.08×10⁻³ mmol/inch² to 1.7×10⁻³ mmol/inch², and is further more preferably from 0.10×10⁻³ mmol/inch² to 1.0×10⁻³ mmol/inch². The attachment amount of the flocculating agent per unit area, is 0.08×10⁻³ mmol/inch² or more, and thereby, the stickiness unevenness and the bleeding may be further suppressed. Additionally, the attachment amount of the flocculating agent per unit area, is 1.8×10⁻³ mmol/inch² or less, and thereby, the stickiness of the recording face may be further enhanced.

In (the case of having) the region (A) and the region of the range which is from the region (A) up to the region (B), the attachment amount of the resin (solid content) which is included in the resin solution per unit area, is preferably from 0.05 mg/inch² to 0.50 mg/inch², and is more preferably from 0.10 mg/inch² to 0.40 mg/inch², and is further more preferably from 0.10 mg/inch² to 0.30 mg/inch². The attachment amount of the resin which is included in the resin solution per unit area, is 0.05 mg/inch² or more, and thereby, the stickiness unevenness and the bleeding may be further suppressed. Moreover, the attachment amount of the resin which is included in the resin solution per unit area, is 0.50 mg/inch² or less, and thereby, the wet abrasion resistance and the stickiness of the recording face may be further enhanced.

### Recording Apparatus

Next, a recording apparatus which can be used in the recording method of the embodiment, will be described. Furthermore, the resin solution is attached to the recording medium, before setting the recording medium to the recording apparatus. FIGURE is a side view illustrating an outline of an example of an ink jet recording apparatus 1 which can be used in the embodiment. As illustrated in FIGURE, the ink jet recording apparatus 1 includes a feed section 10 of the recording medium, a transport section 20, a recording section 30, a drying apparatus 90, and a discharge section 70.

The drying apparatus 90 has a first drying section that dries the reaction solution, and a second drying section 50 that dries the recording material which is obtained by the recording method according to the embodiment.

Moreover, the feed section 10 is arranged so as to feed a roll-shaped recording medium F to the transport section 20. Specifically, the feed section 10 has a roll medium holder 11, and the roll medium holder 11 retains the roll-shaped recording medium F. Therefore, the roll-shaped recording medium F is rotationally moved, and thereby, it is configured so as to feed the recording medium F to the transport section 20 on a downstream side of a feed direction Y.

Furthermore, the transport section 20 is arranged so as to transport the recording medium F which is fed from the feed section 10, to the recording section 30. Specifically, the transport section 20 has a first feed roller 21, and is configured so as to further transport the recording medium F which is fed, to the recording section 30 on the downstream side of the feed direction Y.

Moreover, the recording section 30 is arranged so as to coat the reaction solution with respect to the recording medium F which is fed from the transport section 20, and to perform the recording by discharging the ink composition. Specifically, the recording section 30 includes heads 31 and 32 that perform the attaching of the reaction solution, a recording head 33 that perform the attaching of the ink composition, and a platen 34 which is used as a medium support section.

The platen 34 is arranged so as to support the recording medium F from a rear face. Additionally, in the platen 34, the first drying section 40 that dries the reaction solution which is attached to the recording medium F, and the ink composition which is attached to the recording medium F, is arranged. Furthermore, a second feed roller 43 is arranged on the downstream side of the feed direction Y from the platen 34. Therefore, the second feed roller 43 is configured so as to feed the recording medium F onto which the recording is performed, to the second drying section 50 on the downstream side of the feed direction Y.

Moreover, the second drying section 50 is configured so as to further dry the reaction solution which is attached to the recording medium F, and the ink composition which is attached to the recording medium F. Furthermore, a third feed roller 65 is arranged in the vicinity of an exit 64 of the second drying section 50. The third feed roller 65 is placed so as to be in contact with the rear face of the recording medium F, and is configured so as to feed the recording medium F to the discharge section 70 on the downstream side of the feed direction Y.

Furthermore, the discharge section 70 is arranged so as to further feed the recording medium F which is fed from the second drying section 50, to the downstream side of the feed direction Y, and to discharged the recording medium F to an outside of the ink jet recording apparatus 1. Specifically, the discharge section 70 has a fourth feed roller 71, a fifth feed roller 72, a sixth feed roller 73, a seventh feed roller 74, and a winding roller 75. The fourth feed roller 71 and the fifth feed roller 72 are placed so as to be in contact with the surface of the recording medium F. Still more, the sixth feed roller 73 and the seventh feed roller 74 are placed so as to form a pair of rollers. Therefore, the recording medium F which is discharged by the sixth feed roller 73 and the seventh feed roller 74, is provided so as to be wound by the winding roller 75.

### EXAMPLES

Hereinafter, the invention will be more specifically described by using Examples and Comparative Examples. The invention is not limited by the following examples.

### Materials of Resin Solution, Reaction Solution, and Ink Composition

Main materials of the resin solution, the reaction solution, and the ink composition which are used in Examples and Comparative Examples, are as follows.

### Resin for Resin Solution

Polyester-based resin (manufactured by Toyobo Co., Ltd., trade name “VYLONAL MD-1500”)

### Flocculating Agent

Calcium nitrate tetrahydrate

Citric acid

### Color Material

Carbon black

### Surfactant

Silicone-based surfactant (manufactured by BYK Japan Co., Ltd., trade name “BYK 348”)

### Flocculating Resin

Polyethylene-based resin A (manufactured by Mitsui Chemicals, Inc., trade name “Chemipearl S650”)

Polyethylene-based resin B (manufactured by BYK Co., Ltd., trade name “AQ515”)

Polyethylene-based resin C (manufactured by Unitika Co., Ltd., trade name “KT8701”)

### Solvent

1,2-hexane diol

Propylene glycol

### Preparation of Resin Solution, Reaction Solution, and Ink Composition

Each of the materials are mixed by the compositions which are indicated in Table 1, and are sufficiently stirred. A resin solution J1, reaction solutions H1 and H2, and ink compositions T1 to T4 and K1 are obtained. In Table 1, the unit of numerical values is mass %, and the total is 100.0 mass %.

Flocculating Properties Test of Flocculating Resin which is Included in Ink Composition

3.0 mL of the resin aqueous solution including the resin fine particles of 1 mass %, and 0.10 mL or more and 3.0 mL or less of the calcium nitrate aqueous solution of 0.085 mol/L are mixed, and it is determined with visual observation that whether or not precipitate occurs in a mixed solution. Depending on the following evaluation standards on the basis of a determination result, the flocculating properties of the flocculating resins which are included in the ink compositions, are evaluated.

### Evaluation Standards

A: The calcium nitrate aqueous solution is flocculated to be from 0.10 mL to 1.0 mL.

B: The calcium nitrate aqueous solution is flocculated to be more than 1.0 mL and 3.0 mL or less.

C: The calcium nitrate aqueous solution is flocculated to be more than 3.0 mL.

TABLE 1

| | | Resin | | | | | | | |
|---|---|---|---|---|---|---|---|---|---|
| | | solution | Reaction solution | | Ink composition | | | | |
| Composition no. | | J1 | H1 | H2 | T1 | T2 | T3 | T4 | K1 |
| Resin for | Polyester- | 5 | 0 | 0 | 0 | 0 | 0 | 0 | 0 |
| resin solution | based resin | | | | | | | | |
| Flocculating | Calcium nitrate | 0 | 20 | 0 | 0 | 0 | 0 | 0 | 0 |
| agent | tetrahydrate | | | | | | | | |
| | Citric acid | 0 | 0 | 15 | 0 | 0 | 0 | 0 | 0 |
| Color material | Carbon black | 0 | 0 | 0 | 4 | 4 | 4 | 4 | 0 |
| Surfactant | Silicone-based | 0.6 | 0.6 | 0.6 | 0.6 | 0.6 | 0.6 | 0.6 | 0.6 |
| | surfactant | | | | | | | | |
| Flocculating | Polyethylene- | 0 | 0 | 0 | 1 | 0.6 | 0 | 0 | 5 |
| resin | based resin A | | | | | | | | |
| | Polyethylene- | 0 | 0 | 0 | 0 | 0 | 0 | 1 | 0 |
| | based resin B | | | | | | | | |
| | Polyehylene- | 0 | 0 | 0 | 0 | 0 | 1 | 0 | 0 |
| | based resin C | | | | | | | | |
| Solvent | 1,2-hexane diol | 3 | 3 | 3 | 3 | 3 | 3 | 3 | 3 |
| | Propylene | 15 | 15 | 15 | 10 | 10 | 10 | 10 | 10 |
| | glycol | | | | | | | | |
| | Water | Remainder | Remainder | Remainder | Remainder | Remainder | Remainder | Remainder | Remainder |

| | | | | | | | | |
|---|---|---|---|---|---|---|---|---|
| Total | 100 | 100 | 100 | 100 | 100 | 100 | 100 | 100 |

### Recording Method

### Examples 1 to 10, and Comparative Examples 1 to 3

The resin solution is attached by the roller coating with the attachment amount which is indicated in Tables 2 and 3, to the recording region of the recording medium (NP coated paper manufactured by Lintec Corporation, low absorption media), and the recording medium is sufficiently dried by being heated. The recording medium is carried into PX-G930 (manufactured by Seiko Epson Corporation). Next, the reaction solution is attached by the ink jet system with the attachment amount which is indicated in Tables 2 and 3, to the recording region to which the resin solution is attached. At this time, the recording resolution of the reaction solution is 720×720 dpi. Thereafter, the ink composition is attached by the ink jet system with the attachment amount which is indicated in Tables 2 and 3, to the recording region to which the reaction solution is attached. At this time, the recording resolution of the ink composition is 720×720 dpi. Finally, the recording medium after attaching the ink composition, is dried at 60° C. for 10 minutes, and the recording material is obtained. Furthermore, using the PX-G930, when the reaction solution and the ink composition are coated, a surface temperature of the recording medium is 25° C.

In Tables 2 and 3, a composition attachment amount indicates the attachment amount (actual coating amount including also a volatile component) of the resin solution, the reaction solution, or the ink composition, per unit area in the recording region. Additionally, a solid content attachment amount indicates the attachment amount of the solid content of the resin solution, or the ink composition, per unit area. A flocculating agent attachment amount indicates the attachment amount of the flocculating agent per unit area.

Moreover, in Tables 2 and 3, the ratio (I) indicates a ratio (attachment amount of the solid content: attachment amount of the flocculating agent) of the attachment amount (unit: g) of the solid content which is included in the ink composition per unit area, and the attachment amount (unit: mol) of the flocculating agent per unit area.

In Tables 2 and 3, the region (A) indicates a region where the attachment amount of the solid content which is included in the ink composition per unit area is the largest, in the recording region. Additionally, the region (B) indicates a region where the attachment amount of the solid content of the ink composition per unit area is 20%, when the attachment amount of the solid content which is included in the ink composition per unit area of the region (A), is 100%.

### Stickiness Unevenness and Bleeding

The recording material which is obtained in the above manner, is evaluated on the basis of the following evaluation standards, by confirming the stickiness unevenness and the bleeding.

### Evaluation Standards

A: In the region (A), there is no unevenness on an inside of a pattern. There is no bleeding in the vicinity of the pattern.

B: In the region (A), there is the unevenness on the inside of the pattern, but there is no bleeding in the vicinity of the pattern. In the region (B), there is no unevenness on the inside of the pattern. There is no bleeding in the vicinity of the pattern.

C: In the region (B), there is the unevenness on the inside of the pattern, but there is no bleeding in the vicinity of the pattern.

D: In the region (B), there is the unevenness on the inside of the pattern, and there is the bleeding in the vicinity of the pattern.

### Stickiness

The recording material which is obtained in the above manner, is evaluated on the basis of the following evaluation standards, by confirming the stickiness.

### Evaluation Standards

A: Even when being left for one day in a state of overlapping with the recording faces of two sheets of the recording materials, there is no sticking.

B: When being left for one day in the state of overlapping with the recording faces of two sheets of the recording materials, if one sheet of the recording material is lifted up, the other recording material is stuck to the recording material and is lifted up, but the other recording material is peeled off and is dropped within one minute.

C: When being left for one day in the state of overlapping with the recording faces of two sheets of the recording materials, if one sheet of the recording material is lifted up, the other recording material is stuck to the recording material and is lifted up, and the other recording material is not peeled off and is not dropped even in excess of one minute.

### Wet Abrasion Resistance

Using a Japan Society for the Promotion of Science (JSPS) type rubbing fastness tester AB-301 (trade name manufactured by Tester Sangyo Co., Ltd.), the evaluation of the abrasion resistance of the obtained recording material, is performed. Specifically, the recording face onto which the image is recorded, is dipped into the water, and thereafter, the recording face is reciprocatingly rubbed 10 times by applying a load of 200 g, with a friction block to which the crumpled white cotton cloth (based on JIS L 0803) is stuck. Therefore, the pollution of the white cotton cloth, and the peel-off state of the image (coating film) are visually observed.

### Evaluation Standards

A: The pollution is not observed in the white cotton cloth, and the peel-off of the image is not observed.

B: The pollution is observed in the white cotton cloth, but the peel-off of the image is not observed.

C: The pollution is observed in the white cotton cloth, and the slight peel-off which is within 20% of the area, is observed in the image.

D: The pollution is observed in the white cotton cloth, and the peel-off which exceeds 20% of the area, is observed in the image.

TABLE 2

| | Example 1 | | | | | | Example 2 | | | | | |
|---|---|---|---|---|---|---|---|---|---|---|---|---|
| | Region (A) | | | Region (B) | | | Region (A) | | | Region (B) | | |
| | | | Ink | | | Ink | | | Ink | | | Ink |
| | Resin | Reaction | compo- | Resin | Reaction | compo- | Resin | Reaction | compo- | Resin | Reaction | compo- |
| | solution | solution | sition | solution | solution | sition | solution | solution | sition | solution | solution | sition |
| Composition | J1 | H1 | T1 | J1 | H1 | T1 | J1 | H1 | T1 | J1 | H1 | T1 |
| no. | | | | | | | | | | | | |
| Composition | 2.4 | 2 | 5 | 2.4 | 0.4 | 1 | 2.4 | 1 | 5 | 2.4 | 0.2 | 1 |
| attachment | | | | | | | | | | | | |
| amount | | | | | | | | | | | | |
| (mg/inch²) | | | | | | | | | | | | |
| Solid content | 0.12 | — | 0.25 | 0.12 | — | 0.05 | 0.12 | — | 0.25 | 0.12 | — | 0.05 |
| attachment | | | | | | | | | | | | |
| amount | | | | | | | | | | | | |
| (mg/inch²) | | | | | | | | | | | | |
| Flocculating | — | 1.69 | — | — | 0.34 | — | — | 0.85 | — | — | 0.17 | — |
| agent | | | | | | | | | | | | |
| attachment | | | | | | | | | | | | |
| amount ×10³ | | | | | | | | | | | | |
| (mmol/inch²) | | | | | | | | | | | | |
| Ratio (I) | — | 148:1 | | — | 148:1 | | — | 294:1 | | — | 294:1 | |
| Flocculating | A | | | A | | | A | | | A | | |
| properties of | | | | | | | | | | | | |
| flocculating | | | | | | | | | | | | |
| resin | | | | | | | | | | | | |
| Stickiness | A | | | A | | | A | | | A | | |
| unevenness | | | | | | | | | | | | |
| and bleeding | | | | | | | | | | | | |
| Stickiness | B | | | A | | | A | | | A | | |
| Wet abrasion | B | | | A | | | A | | | A | | |
| resistance | | | | | | | | | | | | |
| | Example 3 | | | | | | Example 4 | | | | | |
| | Region (A) | | | Region (B) | | | Region (A) | | | Region (B) | | |
| | | | Ink | | | Ink | | | Ink | | | Ink |
| | Resin | Reaction | compo- | Resin | Reaction | compo- | Resin | Reaction | compo- | Resin | Reaction | compo- |
| | solution | solution | sition | solution | solution | sition | solution | solution | sition | solution | solution | sition |
| Composition | J1 | H1 | T1 | J1 | H1 | T1 | J1 | H2 | T1 | J1 | H2 | T1 |
| no. | | | | | | | | | | | | |
| Composition | 2.4 | 0.5 | 5 | 2.4 | 0.1 | 1 | 2.4 | 1 | 5 | 2.4 | 0.2 | 1 |
| attachment | | | | | | | | | | | | |
| amount | | | | | | | | | | | | |
| (mg/inch²) | | | | | | | | | | | | |
| Solid content | 0.12 | — | 0.25 | 0.12 | — | 0.05 | 0.12 | — | 0.25 | 0.12 | — | 0.05 |
| attachment | | | | | | | | | | | | |
| amount | | | | | | | | | | | | |
| (mg/inch²) | | | | | | | | | | | | |
| Flocculating | — | 0.42 | — | — | 0.08 | — | — | 0.78 | — | — | 0.16 | — |
| agent | | | | | | | | | | | | |
| attachment | | | | | | | | | | | | |
| amount ×10³ | | | | | | | | | | | | |
| (mmol/inch²) | | | | | | | | | | | | |
| Ratio (I) | — | 595:1 | | — | 595:1 | | — | 320:1 | | — | 320:1 | |
| Flocculating | A | | | A | | | A | | | A | | |
| properties of | | | | | | | | | | | | |
| flocculating | | | | | | | | | | | | |
| resin | | | | | | | | | | | | |
| Stickiness | B | | | A | | | B | | | A | | |
| unevenness | | | | | | | | | | | | |
| and bleeding | | | | | | | | | | | | |
| Stickiness | A | | | A | | | A | | | A | | |
| Wet abrasion | A | | | A | | | A | | | A | | |
| resistance | | | | | | | | | | | | |
| | Example 5 | | | | | | Example 6 | | | | | |
| | Region (A) | | | Region (B) | | | Region (A) | | | Region (B) | | |
| | | | Ink | | | Ink | | | Ink | | | Ink |
| | Resin | Reaction | compo- | Resin | Reaction | compo- | Resin | Reaction | compo- | Resin | Reaction | compo- |
| | solution | solution | sition | solution | solution | sition | solution | solution | sition | solution | solution | sition |
| Composition | J1 | H1 | T1 | J1 | H1 | T1 | J1 | H1 | T1 | J1 | H1 | T1 |
| no. | | | | | | | | | | | | |
| Composition | 4.8 | 1 | 5 | 4.8 | 0.2 | 1 | 1.2 | 1 | 5 | 1.2 | 0.2 | 1 |
| attachment | | | | | | | | | | | | |
| amount | | | | | | | | | | | | |
| (mg/inch²) | | | | | | | | | | | | |
| Solid content | 0.24 | — | 0.25 | 0.24 | — | 0.05 | 0.06 | — | 0.25 | 0.06 | — | 0.05 |
| attachment | | | | | | | | | | | | |
| amount | | | | | | | | | | | | |
| (mg/inch²) | | | | | | | | | | | | |
| Flocculating | — | 0.85 | — | — | 0.17 | — | — | 0.85 | — | — | 0.17 | — |
| agent | | | | | | | | | | | | |
| attachment | | | | | | | | | | | | |
| amount ×10³ | | | | | | | | | | | | |
| (mmol/inch²) | | | | | | | | | | | | |
| Ratio (I) | — | 294:1 | | — | 294:1 | | — | 294:1 | | — | 294:1 | |

| | | | | |
|---|---|---|---|---|
| Flocculating | A | A | A | A |
| properties of | | | | |
| flocculating | | | | |
| resin | | | | |
| Stickiness | A | A | B | A |
| unevenness | | | | |
| and bleeding | | | | |
| Stickiness | B | A | A | A |
| Wet abrasion | B | A | A | A |
| resistance | | | | |

| | Example 7 | | | | | | | |
|---|---|---|---|---|---|---|---|---|
| | Region (A) | | | | Region (B) | | | |
| | | | Ink | Ink | | | Ink | Ink |
| | Resin | Reaction | compo- | compo- | Resin | Reaction | compo- | compo- |
| | solution | solution | sition | sition | solution | solution | sition | sition |
| Composition | J1 | H1 | T2 | K1 | J1 | H1 | T2 | K1 |
| no. | | | | | | | | |
| Composition | 2.4 | 1 | 5 | 0.4 | 2.4 | 0.2 | 1 | 0.08 |
| attachment | | | | | | | | |
| amount | | | | | | | | |
| (mg/inch²) | | | | | | | | |
| Solid content | 0.12 | — | 0.23 | 0.02 | 0.12 | — | 0.05 | 0.004 |
| attachment | | | | | | | | |
| amount | | | | | | | | |
| (mg/inch²) | | | | | | | | |
| Flocculating | — | 0.85 | — | — | — | 0.17 | — | — |
| agent | | | | | | | | |
| attachment | | | | | | | | |
| amount ×10³ | | | | | | | | |
| (mmol/inch²) | | | | | | | | |
| Ratio (I) | — | 294:1 | | | — | 294:1 | | |

| | | |
|---|---|---|
| Flocculating | A | A |
| properties of | | |
| flocculating | | |
| resin | | |
| Stickiness | B | A |
| unevenness | | |
| and bleeding | | |
| Stickiness | A | A |
| Wet abrasion | A | A |
| resistance | | |

TABLE 3

| | Example 8 | | | | | | Example 9 | | | | | |
|---|---|---|---|---|---|---|---|---|---|---|---|---|
| | Region (A) | | | Region (B) | | | Region (A) | | | Region (B) | | |
| | | | Ink | | | Ink | | | Ink | | | Ink |
| | Resin | Reaction | compo- | Resin | Reaction | compo- | Resin | Reaction | compo- | Resin | Reaction | compo- |
| | solution | solution | sition | solution | solution | sition | solution | solution | sition | solution | solution | sition |
| Composition | J1 | H1 | T1 | J1 | H1 | T1 | J1 | H1 | T3 | J1 | H1 | T3 |
| no. | | | | | | | | | | | | |
| Composition | 9.6 | 1 | 5 | 9.6 | 0.2 | 1 | 2.4 | 1 | 5 | 2.4 | 0.2 | 1 |
| attachment | | | | | | | | | | | | |
| amount | | | | | | | | | | | | |
| (mg/inch²) | | | | | | | | | | | | |
| Solid content | 0.48 | — | 0.25 | 0.48 | — | 0.05 | 0.12 | — | 0.25 | 0.12 | — | 0.05 |
| attachment | | | | | | | | | | | | |
| amount | | | | | | | | | | | | |
| (mg/inch²) | | | | | | | | | | | | |
| Flocculating | — | 0.85 | — | — | 0.17 | — | — | 0.85 | — | — | 0.17 | — |
| agent | | | | | | | | | | | | |
| attachment | | | | | | | | | | | | |
| amount ×10³ | | | | | | | | | | | | |
| (mmol/inch²) | | | | | | | | | | | | |
| Ratio (I) | — | 294:1 | | — | 294:1 | | — | 294:1 | | — | 294:1 | |

| | | | | |
|---|---|---|---|---|
| Flocculating | A | A | C | C |
| properties of | | | | |
| flocculating | | | | |
| resin | | | | |
| Stickiness | A | A | C | C |
| unevenness | | | | |
| and bleeding | | | | |
| Stickiness | C | A | A | A |
| Wet abrasion | C | A | A | A |
| resistance | | | | |

Example 10

| | Region (A) | | | Region (B) | | |
|---|---|---|---|---|---|---|
| | | | Ink | | | Ink |
| | Resin | Reaction | compo- | Resin | Reaction | compo- |
| | solution | solution | sition | solution | solution | sition |
| Composition | J1 | H1 | T4 | J1 | H1 | T4 |
| no. | | | | | | |
| Composition | 2.4 | 1 | 5 | 2.4 | 0.2 | 1 |
| attachment | | | | | | |
| amount | | | | | | |
| (mg/inch²) | | | | | | |
| Solid content | 0.12 | — | 0.25 | 0.12 | — | 0.05 |
| attachment | | | | | | |
| amount | | | | | | |
| (mg/inch²) | | | | | | |
| Flocculating | — | 0.85 | — | — | 0.17 | — |
| agent | | | | | | |
| attachment | | | | | | |
| amount ×10³ | | | | | | |
| (mmol/inch²) | | | | | | |
| Ratio (I) | — | 294:1 | | — | 294:1 | |

| | | |
|---|---|---|
| Flocculating | B | B |
| properties of | | |
| flocculating | | |
| resin | | |
| Stickiness | B | B |
| unevenness | | |
| and bleeding | | |
| Stickiness | A | A |
| Wet abrasion | A | A |
| resistance | | |

| | Comparative example 1 | | | | | | Comparative example 2 | | | | | |
|---|---|---|---|---|---|---|---|---|---|---|---|---|
| | Region (A) | | | Region (B) | | | Region (A) | | | Region (B) | | |
| | | | Ink | | | Ink | | | Ink | | | Ink |
| | Resin | Reaction | compo- | Resin | Reaction | compo- | Resin | Reaction | compo- | Resin | Reaction | compo- |
| | solution | solution | sition | solution | solution | sition | solution | solution | sition | solution | solution | sition |
| Composition | J1 | H1 | T1 | J1 | H1 | T1 | J1 | H1 | T1 | J1 | H1 | T1 |
| no. | | | | | | | | | | | | |
| Composition | 2.4 | 1 | 5 | 2.4 | 1 | 1 | 2.4 | 0.2 | 5 | 2.4 | 0.2 | 1 |
| attachment | | | | | | | | | | | | |
| amount | | | | | | | | | | | | |
| (mg/inch²) | | | | | | | | | | | | |
| Solid content | 0.12 | — | 0.25 | 0.12 | — | 0.05 | 0.12 | — | 0.25 | 0.12 | — | 0.05 |
| attachment | | | | | | | | | | | | |
| amount | | | | | | | | | | | | |
| (mg/inch²) | | | | | | | | | | | | |
| Flocculating | — | 0.85 | — | — | 0.85 | — | — | 0.17 | — | — | 0.17 | — |
| agent | | | | | | | | | | | | |
| attachment | | | | | | | | | | | | |
| amount ×10³ | | | | | | | | | | | | |
| (mmol/inch²) | | | | | | | | | | | | |
| Ratio (I) | — | 294:1 | | — | 58:1 | | — | 1470:1 | | — | 294:1 | |

| | | | | |
|---|---|---|---|---|
| Flocculating | A | A | A | A |
| properties of | | | | |
| flocculating | | | | |
| resin | | | | |
| Stickiness | A | A | D | A |
| unevenness | | | | |
| and bleeding | | | | |
| Stickiness | A | C | A | A |
| Wet abrasion | A | D | A | A |
| resistance | | | | |

| | Comparative example 3 | | | | | |
|---|---|---|---|---|---|---|
| | Region (A) | | | Region (B) | | |
| | | | Ink | | | Ink |
| | Resin | Reaction | compo- | Resin | Reaction | compo- |
| | solution | solution | sition | solution | solution | sition |
| Composition | — | H1 | T1 | — | H1 | T1 |
| no. | | | | | | |
| Composition | 0 | 1 | 5 | 0 | 0.2 | 1 |
| attachment | | | | | | |
| amount | | | | | | |
| (mg/inch²) | | | | | | |
| Solid content | 0 | — | 0.25 | 0 | — | 0.05 |
| attachment | | | | | | |
| amount | | | | | | |
| (mg/inch²) | | | | | | |
| Flocculating | — | 0.85 | — | — | 0.17 | 0 |
| agent | | | | | | |
| attachment | | | | | | |
| amount ×10³ | | | | | | |
| (mmol/inch²) | | | | | | |
| Ratio (I) | — | 294:1 | | — | 294:1 | |

| | | |
|---|---|---|
| Flocculating | A | A |
| properties of | | |
| flocculating | | |
| resin | | |
| Stickiness | D | D |
| unevenness | | |
| and bleeding | | |
| Stickiness | A | A |
| Wet abrasion | A | A |
| resistance | | |

In comparison with Comparative Example 1 and Examples, if the ratio (I) is less than 140:1, it is found out that the wet abrasion resistance is degraded due to the moisture absorption of the flocculating agent remaining by unreacting. Moreover, in comparison with Comparative Example 2 and Examples, if the ratio (I) exceeds 650:1, it is found out that the stickiness unevenness and the bleeding occur. Furthermore, in comparison with Comparative Example and Examples, if the resin solution is not used, it is found out that the stickiness unevenness and the bleeding occur.

The entire disclosure of Japanese Patent Application Nos. 2014-070034, filed Mar. 28, 2014 and 2014-109752, filed May 28, 2014 are expressly incorporated by reference herein.

What is claimed is:

1. A recording method comprising:
attaching a resin solution including a resin, to a recording region of a recording medium;
attaching a reaction solution including a flocculating agent which flocculates components of an ink composition, to the recording region to which the resin solution is attached; and
attaching an ink composition including at least any one of a pigment and resin fine particles, to the recording region to which the reaction solution is attached,
wherein in the recording region, when an attachment amount of a region (A) where the attachment amount of a solid content which is included in the ink composition per unit area is the largest is 100%, in a case of having the region (A) and a region of a range which is from the region (A) up to a region (B) where the attachment amount of the solid content is 20%, at the region of the range, a ratio of the attachment amount (unit: g) of the solid content of the ink composition per unit area, and the attachment amount (unit: mol) of the flocculating agent per unit area, is from 140:1 to 650:1.

2. The recording method according to claim 1,
wherein in the attaching of the reaction solution, the reaction solution is attached by an ink jet system, to the recording region to which the resin solution is attached.

3. The recording method according to claim 1,
wherein in the case of having the region (A) and the region of the range, at the region of the range, the ratio of the attachment amount (unit: g) of the solid content which is included in the ink composition per unit area, and the attachment amount (unit: mol) of the flocculating agent per unit area, is from 300:1 to 650:1.

4. The recording method according to claim 1,
wherein when 3 mL of a resin aqueous medium solution including the resin fine particles of 1 mass %, and 3 mL or less of a calcium nitrate aqueous solution of 0.085 mol/L are mixed, the ink composition includes the resin fine particles having flocculating properties, as a resin fine particle.

5. The recording method according to claim 1,
wherein the recording medium is a low absorption recording medium, or a non-absorption recording medium.

6. The recording method according to claim 5,
wherein in the attaching of the ink composition, the ink compositions of two types or more, are attached to the recording region, and
the attachment amount of the solid content which is included in the ink composition per unit area, is a total attachment amount of the solid contents which are included in the ink compositions of two types or more.

7. The recording method according to claim 1,
wherein the ink composition includes a clear ink.

8. The recording method according to claim 1,
wherein in the case of having the region (A) and the region of the range, at the region of the range, the attachment amount of the solid content which is included in the ink composition per unit area, is from 0.04 mg/inch² to 0.40 mg/inch².

9. The recording method according to claim 1,
wherein in the case of having the region (A) and the region of the range, at the region of the range, the attachment amount of the flocculating agent per unit area, is from 0.08×10⁻³ mmol/inch² to 1.8×10⁻³ mmol/inch².

10. The recording method according to claim 1,
wherein in the case of having the region (A) and the region of the range, at the region of the range, the attachment amount of the resin which is included in the resin solution per unit area, is from 0.05 mg/inch² to 0.50 mg/inch².

11. The recording method according to claim 1,
wherein the resin which is included in the resin solution, includes the resin fine particles.

12. The recording method according to claim 1,
wherein the flocculating agent includes at least any one of a polyvalent metal salt and an organic acid.
